(19) United States
(12) Patent Application Publication
(10) Pub. No.: US 2002/0078742 A1
(43) Pub. Date: Jun. 27, 2002

(54) Gear state diagnostic method using frequency demodulation

(76) Inventor: Young-Soo Kim, Seoul (KR)

Correspondence Address: Pennie & Edmonds, LLP, 3300 Hillview Avenue, Palo Alto, CA, 94304, US

(21) Appl. No.: 10/028,214

(22) Filed: Dec. 21, 2001

(30) Foreign Application Priority Data
Dec. 27, 2000 (KR) 2000-82951

(51) Int. Cl. G01M 13/02

(52) U.S. Cl. 73/162

(57) ABSTRACT

A gear state diagnostic method using frequency demodulation includes the steps of (a) detecting a voltage value that is linked to changes in rotational speed of a gear, the voltage value being output by a pulse generator; (b) performing frequency modulation of the voltage value by monitoring means; (c) acquiring the rotational speed of the gear by performing frequency demodulation of the freauency modulated voltage value using sampling method; and (d) monitoring the demodulated frequency and tracking changes in rotation of the gear to determine whether there are errors in the gear.

### BACKGROUND OF THE INVENTION

The present invention relates to a gear state diagnostic method using frequency demodulation. More particularly, the present invention relates to a gear state diagnostic method using frequency demodulation in which a pulse generator is mounted in proximity to a gear within a transmission case, and output signals of the pulse generator are modulated and sampled, after which the signals are demodulated to track changes in gear rotation.

A transmission of a vehicle includes a plurality of gears. Specific gears are meshed with others depending on the required shift range or speed within the ranges. As a result, a rotational force of an input shaft is transmitted to an output shaft according to the resulting gear ratio.

In the development stage of a vehicle, a prototype transmission is constructed and various tests are performed on the transmission. In one such test, it is determined through measurements whether errors are occurring in the transmission gears. There are various ways to perform this test and they include a diagnostic method that detects noise generated by errors in the teeth of a gear, a diagnostic method in which output rpm is displayed on a monitor, a method that uses torque variation signals, among others. To apply such methods, a gear state must be detected. This is realized typically by monitoring using a speed sensor to detect driven gear rpm and CV joint rpm.

There is also a method in which an oscilloscope, a vibroscope and/or an accelerator gauge are provided at a specific location relative to a transmission, and changes in vibrations and/or acceleration are detected such that the generation of errors as soon as they occur may be detected.

FIG. 1 is a graph showing variations in output rpm with elapsed time according to a gear state diagnostic method using a vehicle speed sensor.

In order to detect gear errors during development of the vehicle, vehicle speed detected by a vehicle speed sensor is monitored. That is, output rpm with respect to time is detected, and it is determined by what degree, if at all, the output rpm varies from normal output rpm. If the output rpm does not coincide with normal output rpm, it is determined that a gear error has resulted at the point at which the output rpm strays from the normal output rpm. FIG. 1 illustrates a case where a gear error occurs at roughly 2.0 seconds, resulting in an abrupt drop in vehicle speed (i.e., output rpm).

However, with such conventional diagnostic methods as described above, a significant amount of time and expense are required during initial development stages, and circumstances immediately prior to and following the generation of an error cannot be known such that it is difficult to rectify the causes of errors.

Further, in the case where a vibroscope or a vehicle speed gauge is used to determine whether there are gear errors, although complex overall errors of the transmission are detected, instantaneous changes in speed during rotation and the present condition of error generation of each gear are unable to be measured. Accordingly, the correction of errors as they occur is difficult to perform in a reliable manner.

### SUMMARY OF THE INVENTION

It is one object of the present invention to provide a gear state diagnostic method using frequency demodulation, in which a pulse generator is mounted in proximity to a gear within a transmission case, and output signals of the pulse generator are frequency modulated and sampled, after which the signals are again demodulated to track changes in gear rotation.

In one embodiment, the present invention provides a gear state diagnostic method using frequency demodulation comprising the steps of (a) detecting a voltage value that is linked to changes in rotational speed of a gear, the voltage value being output by a pulse generator; (b) performing frequency modulation of the voltage value by monitoring means; (c) acquiring the rotational speed of the gear by performing frequency demodulation of the frequency modulated voltage value using sampling method; and (d) monitoring the demodulated frequency and tracking changes in rotation of the gear to determine whether there are errors in the gear.

According to a preferred embodiment of the present invention, in step (a), the voltage value expressed as a square wave is converted to a sawtooth wave by the monitoring means using a voltage-frequency converter, and during frequency demodulation, the monitoring means converts the sampled frequency signals into output rpm using frequency demodulation.

According to another preferred embodiment of the present invention, in step (b), it is determined that there are errors in the gear if a trace of changes in rotation of the gear is non-uniform.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a graph showing variations in output rpm with elapsed time;

FIG. 2 is a flow chart of a gear state diagnostic method using frequency demodulation according to a preferred embodiment of the present invention;

FIG. 3 is a schematic view illustrating the mounting of a pulse generator;

FIG. 4 shows graphs of examples of a detection signal and a frequency modulation signal of a pulse generator; and

FIG. 5 is a waveform of rpm calculated by frequency demodulation.

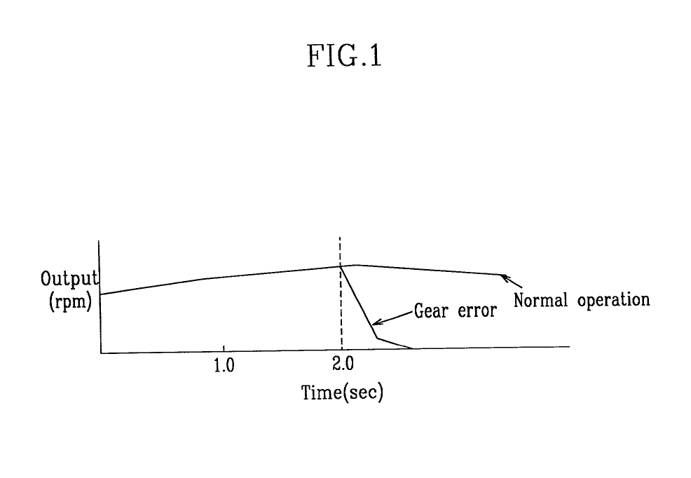

### DETAILED DESCRIPTION OF THE PREFERRED EMBODIMENTS

Preferred embodiments of the present invention will now be described in detail with reference to the accompanying drawings.

According to the present invention, frequency modulation/demodulation is a digital signal processing method for calculating a precise gear rpm. This is realized by transforming a pulse generator signal into a digital signal processing frequency through the frequency modulation, and subsequently by transforming the digital signal processing frequency into an actual rpm through the demodulation as explained in greater detail below.

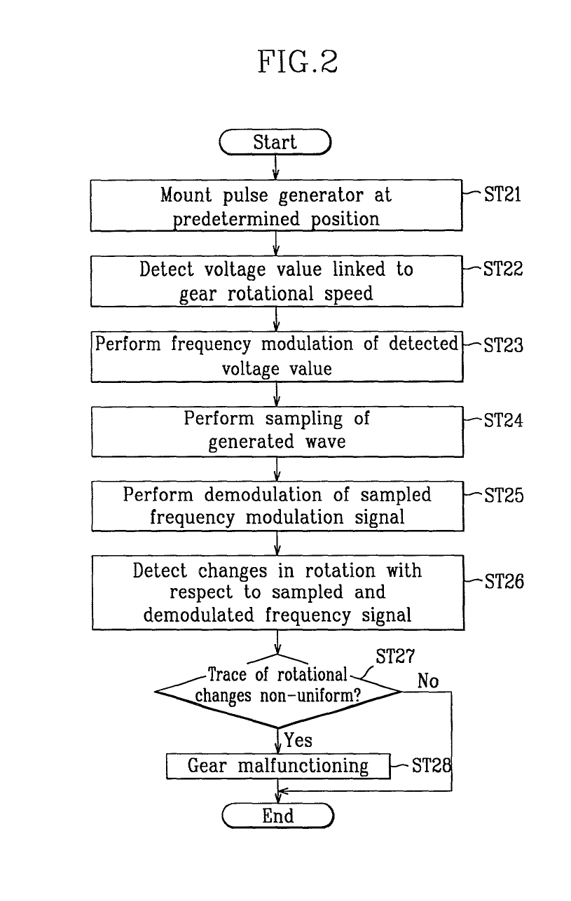

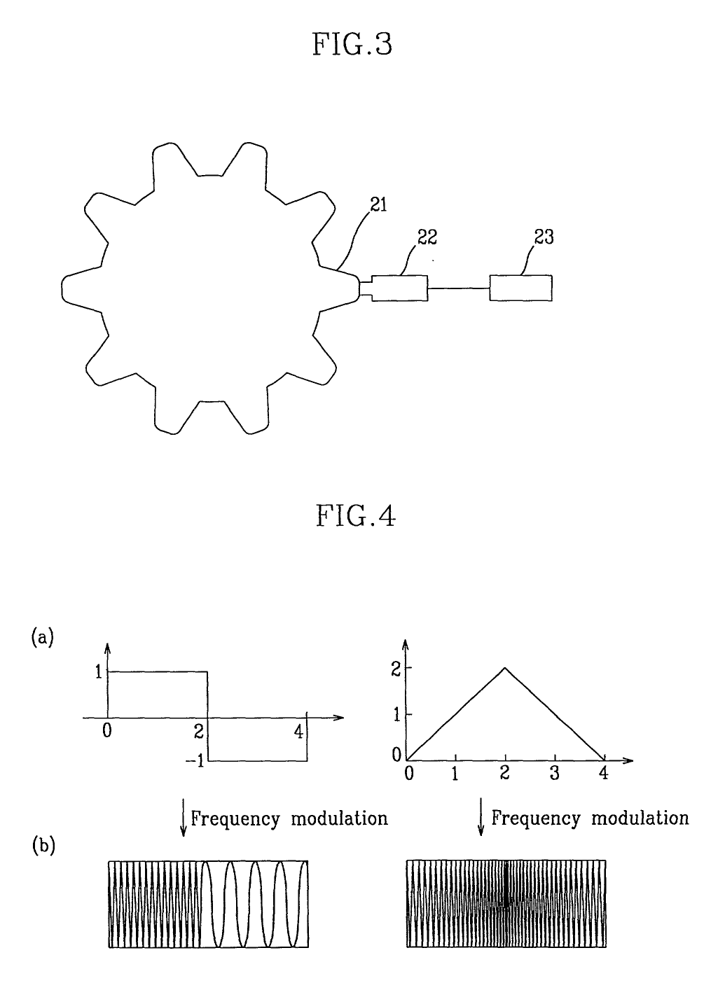

As shown in FIGS. 2 and 3, a pulse generator 22 is mounted at a predetermined position adjacent to a gear 21 that will undergo diagnosis in step ST21. Next, in step ST22, the pulse generator 22 generates a voltage value with a waveform that oscillates between a minimum value and a maximum value as the gear 21 rotates, that is, as the pulse generator 22 alternatingly passes over the tips of the teeth and spaces between the teeth. The voltage value generated by the pulse generator 22 oscillates between a maximum value of 1 and a minimum value of −1 in one period to generate a square waveform as shown in (a) of FIG. 4. Alternatively, the voltage value may be expressed as a sawtooth waveform as also shown. The voltage value generated by the pulse generator 22 is supplied to a monitoring unit 23. The monitoring unit 23 uses a voltage-frequency converter to perform frequency modulation of the input voltage value shown in (a) of FIG. 4 such that a waveform as shown in (b) of FIG. 4 is generated in step ST23. Subsequently, the monitoring unit 23 performs sampling of the generated wave during a predetermined sampling time in step ST24. The frequency modulation signal sampled during this predetermined sampling time is then demodulated using frequency demodulation in step ST25. Further, the monitoring unit 23 detects changes in rotation of total rpm (total frequencies) with respect to the sampled and demodulated frequency signal in step ST26.

First, a carrier wave frequency f_{c} is determined according to the formula: f_{c}=approximate rpm/60 × number of gear teeth. Next, the sampling time Ts is determined based on the nyquist frequency f(nyquist), wherein f(nyquist) =f_{c}Δf. Δf is the bandwidth of the modulated gear tooth ouput signal. Thus, fₛ(min)−2× f(nyquist), where fₛ(min) is the minimum sampling frequency (Hz). As such, the sampling time Ts=1/fₛ(sec). While two times the nyquist frequency is the minimum sampling frequency, it is preferable that the actual sampling frequency (fₛ) be about five to ten times of the above value of f(nyquist) for preventing an alias phenomenon.

Based on the sampling frequency fₛ as determined above, a sequence Xᵣ [n] is acquired from the modulated pulse generator signal. Low pass filtering of Xᵣ [n] is preferably employed to prevent the alias phenomenon.

In order to create a complex sequence, the real band pass signal (Xᵣ [n]) is converted into a complex low pass signal (Z{n}) using the Hilbert Transformation. Based on the transformed low pass signal (Z{n}, the instantaneous change in rotational speed may be determined. In other words, since frequency can represent rotational speed, the instantaneous frequency of the low pass signal becomes the instantaneous change in rotational speed. Because the frequency can be obtained by differentiating a phase, the instantaneous frequency of the low pass signal is obtained from from the following formula: fᵢ=½π{(Δ/Δn)Φ[n]}, where fᵢ equals the instantaneous change in rotational speed, and Φ[n] is the phase of the low pass signal.

This is equal to a value found by subtracting the frequency of a carrier wave from an instantaneous frequency of a band pass signal as follows: change in rotational speed =ΔRPM=½π*(Δ/Δn)( tan⁻¹ (xᵢ<n>/xᵣ<n>)-f_{c}*(60/Nₜₑₑₜₕ), where xi<n> is is the Hilbert Transformation of Xᵣ<n>] (i.e., H[Xᵣ<n>]) xᵣ<n> is the sampled pulse generator signal, and Nₜₑₑₜₕ is the number of gear teeth. Thus, actual instantaneous rotational speed = approximate rotational speed +ΔRPM

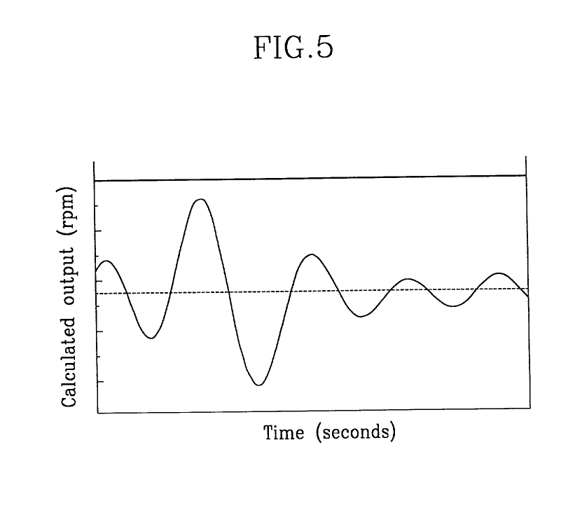

Accordingly, with reference to FIG. 5, changes in output rpm with respect to the passage of time, which are calculated from the frequency demodulation, are tracked such that it may be determined if the inspected gear 21 has errors. That is, changes in the rotation of the gear 21 may be precisely determined to enable early detection of errors.

It is then determined if a corresponding trace from tracking changes in rotation is non-uniform in step ST27. If the rotation is non-uniform, it is determined that the gear is malfunctioning in step ST28, after which the process is ended. In step ST27, if it is determined that the corresponding trace from tracking changes in rotation is uniform, since this is indicative of a normally operating gear, step ST28 is not performed and the process is ended. Monitor 23 may include a processor or may communicate with one or more processors for executing steps ST23 through ST28.

Therefore, with the method of the present invention, in the case where pitting of a gear or damage to the teeth of a gear has occurred, a trace of rotational changes and a resulting waveform are not uniform. Also, in this case, imperfect rpm detection in low-speed rotation and high-speed rotation is possible.

Further, tests performed in development are made easy since the precise diagnosis of gear errors of a prototype transmission is possible. Also, if gear errors are detected early and a trace of rpm change is analyzed, instantaneous changes in rpm with respect to gear teeth may be determined such that the situation prior to and following changes in speed during the meshing of gears may be known. Accordingly, it is possible to perform analysis with respect to the causes of errors during tooth meshing such that gear errors that cause rattling may be easily corrected.

In the gear state diagnostic method using frequency demodulation of the present invention described above, measurements of gear states for gear error diagnosis are precisely performed such that precise and reliable data during high speed rotation of the gear may be obtained. As a result, early determination of the causes of gear errors is possible, and reliable results and determinations may be made in development.

Further, errors generated in each shift range of a transmission may be detected early to thereby prevent damage to the transmission. Accordingly, the time required to completely disassemble the transmission is saved. Additionally, since damage to the transmission is prevented, the number of prototype transmissions used in development is reduced such that overall development costs are reduced. Finally, the dangers and inconvenience involved in conventional methods in which noise and vibrations are detected by performing tests on a running transmission to determine if there are errors are avoided.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A gear state diagnostic method using frequency demodulation comprising:
(a) detecting a voltage value that is linked to changes in rotational speed of a gear, the voltage value being output by a pulse generator;
(b) performing frequency modulation of the voltage value by monitoring means;
(c) acquiring the rotational speed of the gear by performing frequency demodulation of the frequency modulated voltage value; and
(d) monitoring the demodulated frequency and tracking changes in rotation of the gear to determine whether there are errors in the gear.

2. The method of claim 1 wherein in step (a), the voltage value being output by the pulse generator is expressed as a square wave.

3. The method of claim 1 wherein in step (a), the voltage value being output by the pulse generator is expressed as a sawtooth wave.

4. The method of claim 1 wherein in step (d), it is determined that there are errors in the gear if a trace of changes in rotation of the gear is non-uniform.

5. The method of claim 1, wherein said step (c) employs a sampling method.

6. A gear state diagnostic method, comprising:
generating a signal corresponding to a rotational gear speed;
modulating said signal;
demodulating said signal to acquire the gear rotational speed;
monitoring the demodulated signal;
tracking changes in gear rotation based on said monitored signal; and
determining whether errors are present in the gear based on said tracked changes.

7. The diagnostic method according to claim 6, further comprising sampling the modulated signal and wherein said demodulating is a demodulating of the sampled signal.

8. The diagnostic method according to claim 6, wherein said determining step comprises determining whether the changes in gear rotation are non-uniform.

9. The diagnostic method according to claim 6, wherein said signal is a voltage value corresponding to rotational gear speed.

10. The diagnostic method according to claim 9, wherein said voltage value is generated by a pulse generator.

11. The diagnostic method according to claim 9, wherein said modulating step is a frequency modulation and said demodulating step is a frequency demodulation.
